(19) United States
(12) Patent Application Publication
(10) Pub. No.: US 2016/0186950 A1
(43) Pub. Date: Jun. 30, 2016

(54) LIGHTING SYSTEM, IN PARTICULAR FOR A MOTOR VEHICLE LIGHTING MEMBER, COMPRISING A PRINTED CIRCUIT BOARD INCLINED IN RELATION TO THE LIGHTING DIRECTION

(71) Applicant: RENAULT, Boulogne Billancourt (FR)

(72) Inventor: Francois GROSDIDIER, Sermaise (FR)

(73) Assignee: RENAULT s.a.s., Boulogne Billancourt (FR)

(21) Appl. No.: 14/906,157

(22) PCT Filed: Jul. 18, 2014
(86) PCT No.: PCT/FR14/51849

§ 371 Date: Mar. 15, 2016

(30) Foreign Application Priority Data
Jul. 22, 2013 (FR) 1357172

(51) Int. Cl. F21S 8/10; B60Q 3/00

(52) U.S. Cl. CPC F21S 48/1241; F21S 48/1159; B60Q 3/004; F21S 48/2243

(57) ABSTRACT

A lighting system for a motor vehicle headlight includes a rigid printed circuit plate equipped with light-emitting diodes on one face of the rigid plate, the rigid plate being inclined by an angle of 50° to 70° relative to a predetermined lighting direction of the lighting system, and an individual optical module associated with each of the light-emitting diodes. The individual optical module is formed to propagate and guide a light beam emitted by the associated light-emitting diode such that the light beam exiting from the individual optical module is substantially parallel to the lighting direction.

The invention relates to a lighting system, notably for a motor vehicle lighting member, with a printed circuit board inclined relative to the lighting direction.

Some lighting systems comprise a printed circuit board equipped with light-emitting diodes, commonly called LEDs, electrically connected to the printed circuit. A printed circuit board, often referred to by the acronym PCB, is a support, generally a plate, making it possible to electrically link together a set of electronic components in order to produce a complex electronic circuit. This plate is planar and consists of an assembly of one or more thin layers of copper separated by an insulating material. Such a plate can be rigid or flexible. In a lighting device, a printed circuit board, or plate, equipped with LEDs, is generally arranged at right angles to the desired lighting direction for a good light rendition, most of the light beam being emitted by the diodes in a direction at right angles to the printed circuit board. However, in the automotive field and in particular in application in a headlight, such a positioning, at right angles to the lighting direction, imposes a significant bulk on the headlight and constraints on the design.

There is therefore a need for a lighting system that makes it possible to reduce the bulk and vary the design.

To this end, the object of the invention relates to a lighting system, notably for a motor vehicle headlight, comprising a rigid printed circuit plate equipped with light-emitting diodes on one of its faces, characterized in that the rigid plate is inclined by an angle α of 50° to 70° relative to a predetermined lighting direction of the lighting system and in that the lighting system comprises, associated with each light-emitting diode, an individual optical module formed to propagate and guide the light beam emitted by the associated light-emitting diode such that said light beam exiting from said individual optical module is parallel or substantially parallel to the lighting direction.

Thus, each individual optical module is formed to pick up the light beam emitted by the associated diode and straighten it in a direction substantially parallel to the lighting direction. These individual optical modules are notably distinct from one another, with no contact between them in a direction transversal to the lighting direction.

Each light beam, consisting of all the light rays from a light-emitting diode, is thus propagated and guided in the desired direction. A light-emitting diode generally emits a plurality of light rays in a number of directions: the light beam formed by these rays thus generally exhibits a conical form. In the present application, the direction of a light beam is considered to be the direction of the axis of symmetry of the cone delimiting the light beam. Thus, a light beam is parallel (or substantially parallel) to a lighting direction, when the axis of symmetry of the cone delimiting it is parallel (or substantially parallel) to the lighting direction.

The arrangement according to the invention makes it possible to reduce the bulk of the lighting system compared to a lighting system in which the rigid printed circuit plate is oriented at right angles to the desired lighting direction. This saving in bulk can thus make it possible to reduce the weight of a member equipped with such a lighting system and to design such a member with complex stylistic forms. Furthermore, the lighting system makes it possible to obtain a good lighting quality and in particular a uniform lighting.

More particularly, the rigid plate can be inclined by an angle α of 55° to 65°, for example of 60°, relative to said lighting direction.

In other words, a straight line normal to the rigid plate forms an angle β=90°−α with the lighting direction of the lighting system according to the invention.

Advantageously and in a nonlimiting manner, the rigid plate can be positioned vertically, the lighting direction being horizontal.

Advantageously and in a nonlimiting manner, the lighting system can comprise a single printed circuit plate.

Each individual optical module is formed to pick up and straighten a light beam emitted by a light-emitting diode. This can be obtained by choosing a suitable form and/or material for the production of this individual optical module. As an example, a part of the individual optical module can have a straightening function, for example obtained by an appropriate orientation of its walls allowing for a reflection of an incident ray in a direction parallel or substantially parallel to the lighting direction or toward another reflecting wall for a new orientation in a direction closer to the lighting direction. Such walls can be determined by the laws of optics as a function of the characteristics of the light beam emitted by a diode and of the inclination of the rigid plate.

Advantageously and in a nonlimiting manner, each individual optical module can comprise a light beam input positioned facing the associated light-emitting diode and a light beam output and each individual optical module can comprise, on the side of its input, a part for straightening the light beam formed to straighten said light beam in a direction substantially parallel to the lighting direction.

The input of an individual optical module can be a reception surface, for example a planar surface substantially at right angles to the light beam emitted by the associated LED.

The positioning of the individual optical module relative to the associated light-emitting diode can be chosen in order to make it possible for the optical module to pick up most of the light radiation emitted by the diode. Preferably, the individual optical module can be positioned so as to pick up from 70 to 100% of the light radiation emitted, preferably from 80 to 100% of the radiation, even from 90 to 100% of the radiation. For example, the individual optical module can thus be situated at a distance of the order of 0.5 to 5 cm from the associated light-emitting diode.

Advantageously and in a nonlimiting manner, the lighting system according to the invention further comprises at least one collecting optical module connected to a plurality of individual optical modules, said collecting optical module being formed to propagate and guide the light beams originating from the individual optical modules. This can make it possible to improve the uniformity of the light flux exiting from the lighting system. This arrangement also makes it possible to produce a shaping of the light flux exiting from the lighting system, which has the same form as the output of the collecting module. The light beams originating from the individual optical modules are thus guided from an input to an output of a collecting optical module. This input receives the light beams exiting from a number of individual optical modules, which then exit through the output of the collecting optical module, generally formed by a free end thereof. In particular, each individual optical module can be identical and the outputs of a plurality of individual optical modules can be connected to an input of a collecting optical module. In other words the input of the collecting optical module, for example a planar surface, is parallel or substantially parallel to the rigid plate supporting the light-emitting diodes. This arrangement can also make it possible to enhance the uniformity of the light flux exiting from the lighting system.

The light-emitting diodes can be arranged in rows on the rigid plate. The collecting optical module can then be connected to the individual optical modules associated with the light-emitting diodes of a row, which can allow for a simpler production of the collecting optical module.

Whatever the arrangement of the light-emitting diodes on the rigid plate, two collecting optical modules can be produced of a piece, thus making it possible to increase the emission surface of the light flux exiting from the lighting system.

The invention is not however limited by the form and the arrangement of a collecting optical module, nor by the arrangement of the light-emitting diodes on the rigid plate.

Advantageously and in a nonlimiting manner, in order to avoid losses of light rays between the individual optical modules and the collecting module connected thereto, each collecting optical module can be produced of a piece with the individual optical modules to which it is connected.

Advantageously and in a nonlimiting manner, each individual optical module, and possibly each collecting optical module, can be formed in a polymer material or in glass, preferably translucent or transparent, suitable for propagating and guiding at least one light beam circulating within its volume, notably a light beam emitted by light-emitting diodes. The material used can be any material suitable for guiding light radiation, such as a material of glass or polymer type, colored or not, for example polycarbonate or poly(methylmethacrylate) (PMMA). Each optical module can thus be produced simply and its form can be adapted to the member intended to receive the lighting system. In particular, the shaping of the individual optical modules can be obtained by a process of spark erosion machining of the material forming the module.

Whatever the arrangement of the light-emitting diodes, one or more masks can be arranged so as to partially or totally fill any space separating the individual optical modules and/or the collecting optical modules, in particular separating the collecting optical modules on the side of the lighting system through which the light beams exit, thus making it possible to more clearly define the form of the light flux exiting from the lighting system. These masks also make it possible to conceal technical parts situated behind these masks and the visibility of which from the outside of the lighting system is undesirable.

When a number of collecting optical modules are provided, they are preferably formed in such a way as to not enter into contact with one another. This makes it possible to improve the guiding of the light beams.

The invention also relates to a motor vehicle lighting member equipped with a lighting system according to the invention.

This lighting member can notably be chosen from a headlight for vehicle signaling and an ambience light intended to be situated inside the vehicle interior. Preferably, the member is a headlight.

A lighting member usually comprises a casing, one face of which is translucent or transparent for the exiting of the light beam. The rigid printed circuit plate is then arranged inside the casing and fixed thereto, the direction of the lighting system being such that the light beams exit through the translucent or transparent face of the casing.

Another object of the invention relates to a motor vehicle equipped with at least one lighting system according to the invention.

In particular, said lighting system can equip at least one of the following members:

an ambience light situated inside the vehicle interior,

a vehicle signaling light.

This signaling light, front or rear, can notably be chosen from a daytime running light (light which comes on automatically when the vehicle starts moving, also known by the acronym DRL), a side light, a reversing light, a fog light, a flashing light, a stop light or any other signaling light.

The invention is now described with reference to the attached nonlimiting drawings in which:

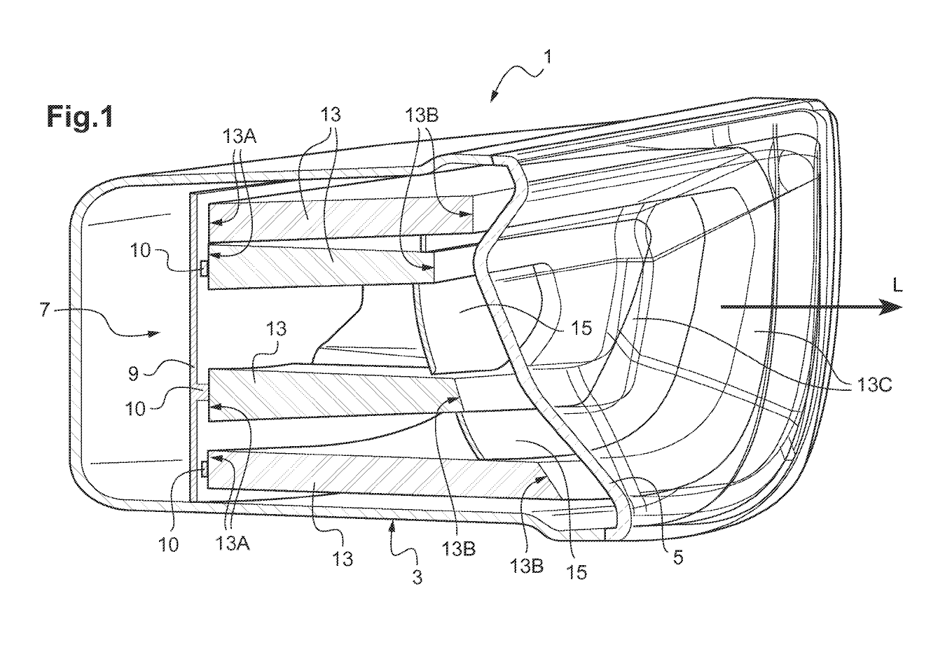

FIG. 1 is a cross sectional and perspective view of a vehicle headlight equipped with a lighting system according to the invention;

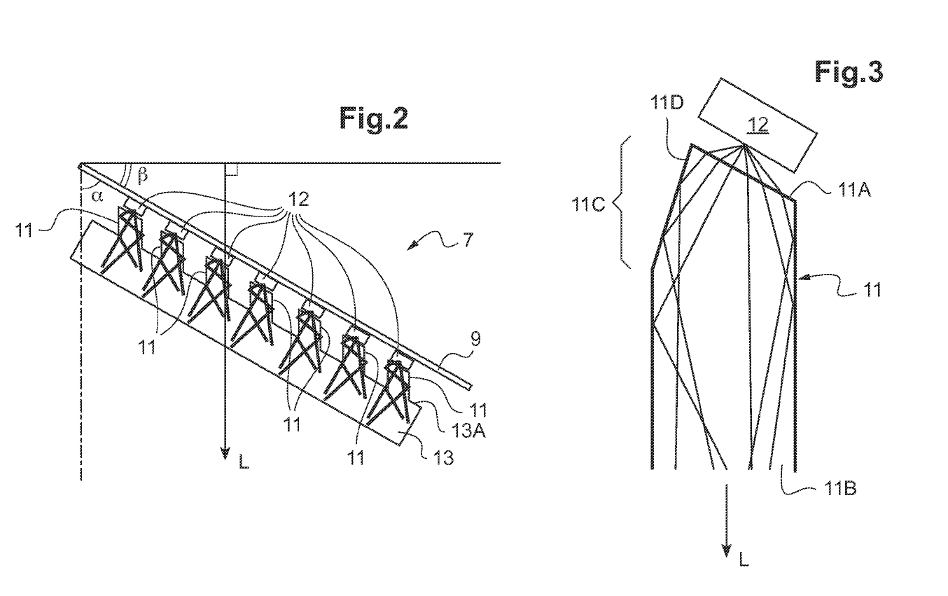

FIG. 2 is a partial schematic representation of a lighting system according to the invention, in cross section according to the lighting direction, along a row of light-emitting diodes showing individual optical modules connected to a collecting optical module;

FIG. 3 is an enlargement of an individual optical module of FIG. 2.

“Substantially parallel” should be understood to mean a direction forming an angle of at most ±20° or of at most ±10° with a particular direction.

FIG. 1 represents a headlight 1 for the vehicle signaling, comprising a casing 3 of which one face 5 is translucent or transparent for the exiting of the light beams in a lighting direction L. This face 5 can adopt any planar or more complex form as in the example represented.

This headlight 1 is equipped with a lighting system 7 which comprises a rigid printed circuit plate 9 equipped with light-emitting diodes 12 on one of its faces. These light-emitting diodes are arranged in rows in the example represented. This rigid plate 9 is arranged inside the casing 3, fixed thereto by any appropriate means.

According to the invention, the rigid plate 9 is inclined by an angle α of 50° to 70° relative to a predetermined lighting direction of the lighting system. In the example represented, the lighting direction of the lighting system 7 coincides with the lighting direction L of the headlight 1. In the example, the angle α is 60°, in other words, the angle between a plane normal to the lighting direction and the inclined plate is 30°.

In the example represented, the lighting direction L is substantially horizontal, parallel to the longitudinal direction of the vehicle equipped with the headlight 1, and the rigid plate 9 is vertical. The inclination of the rigid plate 9 can thus be obtained following a rotation of vertical axis from a position normal to the lighting direction L. However, the invention is not limited by an inclination as represented, another inclination of the rigid plate 9, resulting for example from a rotation about a longitudinal or transverse axis of the vehicle (still from a position normal to the lighting direction), also making it possible to reduce the bulk of the lighting system according to the invention.

According to the invention, the lighting system 7 further comprises, associated with each light-emitting diode 12, an individual optical module 11 formed to propagate and guide the light beam emitted by the associated light-emitting diode 12 such that said light beam exiting from said individual optical module 11 is substantially parallel to the lighting direction. Notably, FIG. 3 schematically shows the light rays emitted by the light-emitting diode 12 and their path within the volume of the individual optical module 11.

The rigid plate 9 is thus equipped with a plurality of individual optical modules 11, as can be seen partially in FIG. 2, which represents the rigid plate 9 in cross section along a row 10 of light-emitting diodes 12.

Referring to FIG. 3, an individual optical module 11 comprises a light beam input 11A positioned facing the associated light-emitting diode 12 and a light beam output 11B. The light beam input 11A is for example a planar surface, substantially at right angles to the light beam emitted by the LED 12.

The individual optical module 11 further comprises, on the side of its input 11A, a part 11C for straightening the light beam formed to straighten said light beam in a direction substantially parallel to the lighting direction L. This straightening part 11C comprises, in the example represented, a wall 11D inclined in such a way as to reflect the incident rays toward the output 11B of the individual module, substantially parallel to the lighting direction L. This inclination of the wall 11D can be determined according to the laws of optics as a function of the nature of the light-emitting diode and of the position of the individual optical module.

The lighting system 7 according to the invention further comprises a number of collecting optical modules 13 each connected to a plurality of individual optical modules 11. Each collecting optical module 13 is formed to propagate and guide the light beams originating from the individual optical modules 11. The outputs 11B of a plurality of individual optical modules 11 are thus connected to an input 13A of a collecting optical module 13.

To simplify production, each individual optical module 11 is preferably identical. In this case, the input 13A of the collecting optical module 13 has a general form substantially parallel to the rigid plate 9, as can be seen in FIG. 2. It should be noted that, in FIG. 2, the collecting optical module 13 is represented partially. The collecting optical modules 13 are represented more fully in FIG. 1. In this FIG. 1, it is also possible to distinguish the output 13B of each collecting optical module 13, through which exits the light flux formed by all of the light beams emitted by the light-emitting diodes 12, straightened by the individual optical modules 11 then collected by the collecting optical modules 13. This output 13B forms an emission surface of the light beams in the example, substantially planar emission surface.

In the example represented, four collecting optical modules 13 are represented, each connected to a row 10 of light-emitting diodes 12. Furthermore, these collecting optical modules 13 are linked in pairs via a part 13C. In other words, two collecting optical modules 13 linked via a part 13 are produced in a single piece.

In order to avoid a loss of light rays, each collecting optical module 13 is produced of a piece with the individual optical modules 11 to which it is connected, as is the case in the example represented.

In the example represented, the individual optical modules 11 and the collecting optical modules 13 are produced in a polymer material suitable for propagating and guiding a light beam circulating within the volume of the optical modules.

Finally, FIG. 1 shows masks 15, arranged in such a way as to fill the space separating the outputs 13B of the collecting optical modules 13. The collected light beams thus exit only through the free ends of the collecting optical modules 13.

The lighting member described with reference to FIG. 1 is a motor vehicle headlight.

However, the invention is in no way limited by the type and the form of the lighting member, which can also be an interior or exterior lighting member, for a vehicle or a building.

The lighting system according to the invention in effect offers the advantage of being able to be used in numerous members of which the aim is in particular to reduce the bulk and the weight.

1-10. (canceled)

11. A lighting system for a motor vehicle headlight, comprising:
a rigid printed circuit plate equipped with light-emitting diodes on one face of the rigid plate, the rigid plate being inclined by an angle of 50° to 70° relative to a predetermined lighting direction of the lighting system;
an individual optical module associated with each of the light-emitting diodes and formed to propagate and guide a light beam emitted by the associated light-emitting diode such that said light beam exiting from said individual optical module is substantially parallel to the lighting direction.

12. The lighting system as claimed in claim 11, wherein the rigid plate is inclined by an angle of 55° to 65° relative to said lighting direction.

13. The lighting system as claimed in claim 11, wherein each individual optical module comprises a light beam input positioned facing the associated light-emitting diode and a light beam output, and each individual optical module comprises, on a side of the input, a part for straightening the light beam formed to straighten said light beam in a direction substantially parallel to the lighting direction.

14. The lighting system as claimed in claim 11, further comprising:
at least one collecting optical module connected to a plurality of the individual optical modules, said collecting optical module being formed to propagate and guide the light beams originating from the plurality of the individual optical modules.

15. The lighting system as claimed in claim 14, wherein each of the plurality of the individual optical modules is identical and outputs of the plurality of the individual optical modules are connected to an input of the collecting optical module.

16. The lighting system as claimed in claim 14, wherein the light-emitting diodes are arranged in rows on the rigid plate and the collecting optical module is connected to the individual optical modules associated with the light-emitting diodes of a same row.

17. The lighting system as claimed in claim 14, wherein each of the collecting optical modules is produced as a piece with the individual optical modules to which it is connected.

18. The lighting system as claimed in claim 11, wherein each of the individual optical modules is formed in a polymer material suitable for propagating and guiding at least one light beam circulating within a volume of the polymer material.

19. The lighting system as claimed in claim 18, wherein the polymer material is translucent or transparent.

20. The lighting system as claimed in claim 11, wherein each of the individual optical modules and each collecting optical module is formed in a polymer material suitable for propagating and guiding at least one light beam circulating within a volume of the polymer material.

21. The lighting system as claimed in claim 20, wherein the polymer material is translucent or transparent.

22. A motor vehicle lighting member, comprising:
a lighting system as claimed in claim 11.

23. A motor vehicle, comprising:
at least one lighting system as claimed in claim 11, said at least lighting system being included in at least one of:
an ambience light situated in an interior of the vehicle, and
a signaling light of the vehicle.
